(19) United States
(12) Patent Application Publication
(10) Pub. No.: US 2007/0050117 A1
(43) Pub. Date: Mar. 1, 2007

(54) Steering system for a vehicle

(76) Inventors: Christian Kitzler, Cloppenburg (DE); Ludger Autermann, Drensteinfurt (DE); Michael Quinckhardt, Warendorf (DE)

Correspondence Address: STRIKER, STRIKER & STENBY, 103 EAST NECK ROAD, HUNTINGTON, NY, 11743, US

(21) Appl. No.: 11/511,926

(22) Filed: Aug. 29, 2006

(30) Foreign Application Priority Data
Aug. 31, 2005 (DE) 10 2005 041 550

(51) Int. Cl. B62D 6/00

(52) U.S. Cl. 701/50; 701/41

(57) ABSTRACT

A steering system for a vehicle has at least one data processing device, a track following system for determining a driving route and enabling the vehicle to be steered automatically via the at least one data processing device, the track following system including at least one first driving route detection system and at least one further driving route detection system, the driving route detection systems being coupled via the at least one data processing device such that it is possible to switch between the driving route detection systems.

### CROSS-REFERENCE TO A RELATED APPLICATION

The invention described and claimed hereinbelow is also described in German Patent Application DE 10 2005 041 550.4 filed on Aug. 31, 2005. This German Patent Application, whose subject matter is incorporated here by reference, provides the basis for a claim of priority of invention under 35 U.S.C. 119(a)-(d).

### BACKGROUND OF THE INVENTION

The present invention relates to a steering system for a vehicle with a track-following system.

The use of track-following systems in vehicles, e.g., in agricultural machines, for the fully automatic or semi-automatic guidance of these vehicles along characteristic virtual or real lines is of extremely practical significance because they largely relieve the vehicle driver of the need to perform steering operations, some of which require a great deal of skill. This is in addition to traditional mechanical track-following systems that usually detect—using mechanical detectors—characteristic lines in the territory to be worked and, based on the contours that are detected, generate steering signals that guide the particular vehicle along these detected contours. Since systems of this type can scan the territory in front of the vehicle only to a very limited extent, these systems are being increasingly replaced by electronic systems that can usually sense the territory to be worked far ahead of the vehicle. Due to the ability of systems of this type to detect the territory to be worked far ahead of the vehicle, the inertia of the particular steering systems can be taken into account to a much better extent.

GPS-based systems are widespread in the field of electronic driving route detection systems. Reference is hereby made to DE 101 29 135 A1 as an example, in which “GPS steering” is disclosed, using a combine harvester as an example. GPS-based devices for determining position have the disadvantage, however, that signal corruptions caused, in particular, by transit-time errors in the GPS signal or by receiving disturbances can result in considerable disturbances in the automatic steering of the vehicle. Under certain circumstances, this can result in the vehicle being steered off of the actual track to be worked, which worsens the working quality of the vehicle considerably.

To limit these disadvantages, it is provided in DE 101 29 135 to couple the GPS-based driving route detection system with a further driving route detection system, e.g., a laser scanning system or an image-processing system. The position signals generated by the particular systems are then brought into relation with each other in a control and evaluation system, and a decision algorithm evaluates the quality of the signals and provides a corrected position signal in accordance with the weighting of the quality information. The main disadvantage of a system of this type is that it is always coupled to the position data of two driving route detection systems. If one or both position signals are lacking, a default position signal is generated, which can deviate considerably from the actual position of the vehicle. This deviation can be that much greater the poorer the quality is of the position signals received from the individual driving route detection systems.

Nor does an interplay of this type between a plurality of driving route detection systems take into account the fact that, when distinct optical reference lines exist in the territory to be worked, driving route detection systems that sense the territory directly provide more accurate position data than do GPS-based systems, since they depict the actual conditions in the territory immediately. In an embodiment according to DE 101 29 135, these position signals are used only to correct the GPS-based position data.

Since a large number of applications requires that the actual geographical conditions in a territory to be worked be depicted precisely, systems have been made known in the related art, e.g., DE 103 28 395, with which the determination of position data using GPS has been replaced entirely by camera-based systems. In the system described, the path driven by the agricultural vehicle—designed as a tractor—is recorded using an image recognition device located on the tractor. The images that are generated are subsequently compared in a control and evaluation unit with image data of the desired driving track and, depending on the results of the comparison, the driving track is corrected via generation of the required steering signals.

Due to the fact that the track-following system disclosed in DE 103 28 395 forces the vehicle to follow a predefined driving track in a manner similar to that of GPS-based systems, this desired driving track must first be created. In addition, this predefined driving track can deviate considerably from the real condition if the territory would have to be driven along a route that is not the predefined driving track, in order to avoid driving over new plant growth. In a case such as this, plant stands would be driven over and yields would be reduced. The same disadvantages occur with systems of this type as they do for GPS-based systems, since a system according to DE 103 28 395 is a structural reproduction of a GPS-based system.

### SUMMARY OF THE INVENTION

The object of the present invention, therefore, is to avoid the disadvantages of the related art described above and, in particular, to provide automatic steering for vehicles with track-following systems that ensures high working quality, even when the structure of the territories to be worked changes.

In keeping with these objects and with others which will become apparent hereinafter, one feature of the present invention resides, briefly stated, in a steering system for a vehicle, comprising at least one data processing device; a track following system for determining a driving route and enabling the vehicle to be steered automatically via said at least one data processing device, said track following system including at least one first driving route detection system and at least one further driving route detection system, said driving route detection systems being coupled via said at least one data processing device such that it is possible to switch between said driving route detection systems.

Due to the fact that the track-following system includes at least one first driving route detection system and at least one further driving route detection system—the driving route detection systems being coupled via a control unit such that it is possible to switch between the driving route detection systems—it is ensured that the track-following system allows high working quality to be attained even when the structure of the territories to be worked changes.

A technically mature and universally applicable design of the track-following system results when the first driving route detection system is a GPS-based driving route detection system. A system of this type has the advantage, in particular, that it is relatively independent of dust that is stirred up by use of the working machine, and it delivers very precise position data to the working machine.

To ensure that the inventive track-following system is universally applicable, the second driving route detection system is a camera-based driving route detection system. This has the advantage, in particular, that automatic steering of the working machine is also possible when digitized driving routes are not available for the territory to be worked, or, in a growing stand of plants, when the working machine must follow the track very precisely to avoid damaging the plants.

In an advantageous refinement of the present invention, the camera of the camera-based driving route detection system is designed as a 3-D camera, thereby enabling the the generation of a spacial depiction of the territory to be worked and, based thereon, driving tracks for the working vehicle.

A mature design of the 3-D camera results when the 3-D camera is defined by a two-camera system located such that it is offset at an angle, or by a 2-D camera with transit-time measurement.

Since camera-based driving route detection systems therefore make it possible for tracks to be followed more precisely when the driving route of the vehicle must be adapted very uniquely to the actual local conditions in the territory to be worked, it is provided in an advantageous embodiment of the present invention that it is possible to switch between the driving route detection systems via reference to regulating criteria and/or by the operator.

In the simplest case, the regulating criteria are defined by the presence or absence of optical reference lines in the territory to be worked, the optical reference lines being formed by driving paths and/or plant rows and/or crop edges.

A high degree of flexibility of automatic track-following and high working quality by the vehicle is attained when, if optical reference lines are present and/or if digitized driving routes are missing in the territory to be worked, the track-following system is operated by the driving route-detection system that includes the camera.

In an advantageous refinement of the present invention, the automatic steering of an agricultural working machine in the territories to be worked—in which driving over the plants is not an issue—can be operated very efficiently when, if optical reference lines are missing and/or if digitized driving routes are not available for the territory to be worked, the track-following system is operated by the GPS-based driving route-detection system.

A particularly simple integration of the inventive track-following system in a vehicle results when the GPS-based driving route detection system and the driving route detection system that includes the camera are linked with each other via a controller, and the controller links the driving route detection systems with a steering circuit.

The driver of the agricultural working vehicle is relieved of a lot of work when the controller defines the regulating criteria for selecting the driving route detection system. The track-following process could then be largely automated, thereby enabling the driver of the agricultural working machine to concentrate on monitoring the highly diverse working processes.

A compact design of the control electronics of the inventive track-following system is attained by the fact that the controller generates the input signals for the steering circuit directly out of the output signals of the driving route detection systems.

To make driving routes determined using a camera-based system reproducible for subsequent processing steps, it can be provided in an advantageous embodiment of the present invention that the camera-based driving route detection system is linked with the GPS-based driving route detection system such that, when the vehicle is operated using the camera-based driving route detection system, the driving route is recorded in a geo-referenced manner in conjunction with the GPS-based route detection system.

Universal use of the inventive track-following system is attained in an advantageous refinement of the present invention when the track-following system is modular in design and the driving route detection systems are integrated in the track-following system in a replaceable manner.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic side view of a vehicle with an inventive steering device.

FIG. 2 shows two applications of the inventive track-following system of the inventive steering device.

FIG. 3 shows a detailed view of the three-dimensional image of the territory to be worked generated by the inventive steering device.

FIG. 4 is a flow chart that illustrates the relationship between regulating criteria, optical reference lines and predefined driving routes.

### DESCRIPTION OF THE PREFERRED EMBODIMENTS

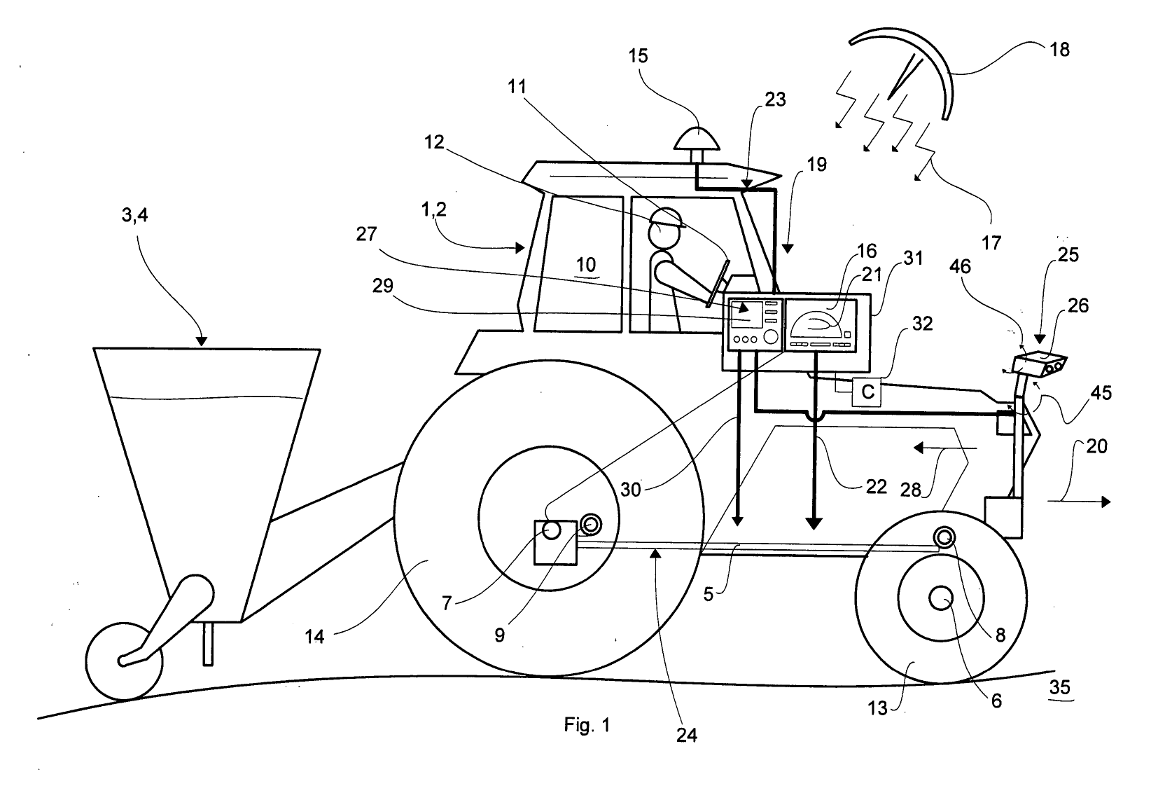

FIG. 1 shows an agricultural working machine 1 designed as a tractor 2, to the rear region of which a processing device 3 designed as a fertilizer spreader 4 is coupled. It is within the scope of the present invention that processing device 3 can have any possible design and can be adapted to carrier vehicle 1 at any point. Reference is made here as an example to the fact that processing device 3 can also be designed as a field cultivator, an aerator, a herbicide sprayer, or, e.g., as a single-component or multiple-component cutting mechanism assigned to the tractor at various positions.

Tractor 2, which is known per se, includes a hydraulic steering circuit 5 that is operatively connected in a manner known per se with front axle 6 and/or rear axle 7 and/or steering cylinders 8, 9 assigned to wheels 13, 14. Using steering wheel 11 located in vehicle cab 10, driver 12 of tractor 2 can regulate, in a conventional manner, the pressure that is applied to steering cylinders 8, 9 and therefore steer tractor 2, it being possible to steer wheels 13 of front axle 6 and wheels 13, 14 of a vehicle axis 6, 7 together, or to steer each wheel 13, 14 separately, depending on the embodiment of steering circuit 5.

Tractor 2 has a GPS-sensor 15 on the roof of the cab that generates GPS-based position signals 19 of tractor 2 based on position signals 17 from GPS-satellite systems 18 and is coupled to a data processing unit 16. In a manner known per se, these position signals 19 of tractor 2 can be used to record driving route 20 covered by tractor 2. A GPS-based, automatic steering of tractor 2 is conventionally designed such that, in the simplest case, the driving route of tractor 2 determined in a GPS-based manner is compared with a desired driving track 21 stored in data processing unit 16. If the determined driving route 20 deviates from desired driving track 21, steering signals 22 are generated in data processing unit 16 that automatically intervene in steering circuit 5 and bring about an adaptation of actual driving route 20 to desired driving route 21 via an adjustment of steering cylinders 8, 9.

According to the present invention, GPS sensor 15 and associated data processing device 16 define a first driving route detection system 23 of a track-following system 24 that includes GPS sensor 15, data processing device 16 and steering circuit 5 described above, and at least one further driving route detection system 25. In the exemplary embodiment shown, further driving route detection system 25 includes an image recognition system 26 that is assigned to front side of tractor 2 and will be described in greater detail below, image recognition system 26 being coupled with a data processing device 27 such that image signals 28 are converted in data processing device 27 into real images 29 of recorded territory 35 and are optionally displayed.

Furthermore, data processing device 27 assigned to image recognition system 26 generates steering signals 30 that, in manner similar to that of GPS-based driving route detection system 23, can bring about the automatic steering of tractor 2 via an automatic intervention in steering circuit 5. In the exemplary embodiment shown in FIG. 1, each driving route detection system 23, 25 includes a separate data processing device 16, 27. It is within the scope of the present invention for one data processing device 31 to be assigned to both driving route detection systems 23, 25. Depending on the embodiment, a controller 32 is assigned to separate data processing devices 16, 27 or shared data processing device 31 in a manner according to the present invention, controller 32 making it possible to switch between driving route detection systems 23, 25 such that track-following system 24 accesses either GPS-based or camera-based position data, on the basis of which particular steering signals 22, 30 are subsequently generated and transmitted to steering circuit 5.

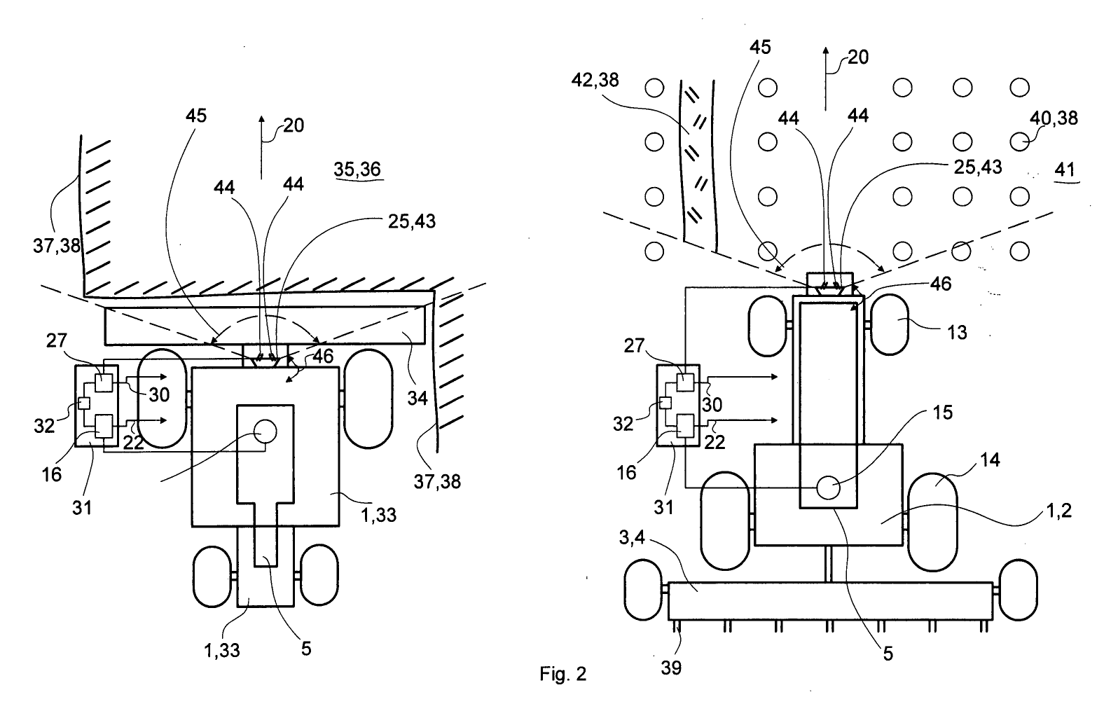

While first driving route detection system 23 defines a GPS-based driving route detection system 23 that is known per se and will therefore not be described in greater detail, further camera-based driving route detection system 25 will be described in greater detail below with reference to FIG. 2. FIG. 2 depicts two applications of the inventive steering system. In the depiction shown at the left, working machine 1 is a combine harvester 33, to the front side of which a grain cutting device 34 is assigned that harvests a grain stand 36 located on territory 35 to be worked and transfers it to combine harvester 33. When grain stand 36 is harvested, stand edges 37 results, which simultaneously represent optical reference lines 38 in territory 35 to be worked.

The application depicted in FIG. 1 is shown in a top view in the depiction on the right. Processing device 3, which is shown in a greatly simplified view and is designed as a fertilizer spreader 4, includes fertilizer output elements 39 that can apply fertilizer directly to individual plant rows 40. A system of this type is a typical application for working in a growing stand 41, it being possible for growing stand 41 to be rows of corn and beet plants or various vegetables, potato mounds, etc. In stands of this type, driving paths 42 are usually easily to see. With this application, plant rows 40 and driving paths 42 are the optical reference lines 38 of stand 41 growing in territory 35 to be worked.

Every agricultural working machine 1, 2, 33 includes GPS sensor 15 described above and data processing device 16 assigned thereto, data processing device 16 generating steering signals 22 to be transmitted to steering circuit 5. In addition, every working machine 1, 2, 33 includes a further driving route detection system 25 in its front region that also generates—via a data processing device 27—a steering signal 30 to be transmitted to steering circuit 5. Furthermore, a controller 32 is assigned to data processing devices 16, 27 that makes it possible to switch between the two driving route detection systems 23, 25 in the manner known according to the present invention.

In the exemplary embodiment shown, camera-based further driving route detection system 25 is a 3-D camera 43 that is formed, in a manner known per se, out of two conventional cameras 44 located at a defined angle relative to each other, the generation of the three-dimensional image being determined using appropriate software. The image can be created, e.g., in controller 32 and/or a data processing device 16, 27, 31. It is within the scope of the present invention for the 3-D camera to also be a single-camera system; this camera is then designed such that the transit time of the light beams that determine the image points is used to determine the third dimension. To ensure that 3-D camera 43 can detect the largest possible image area of territory 35 to be worked, camera-based, further driving route detection system 25 is located on particular agricultural working machine 1 such that it can swivel in the horizontal and vertical directions as indicated by arrow directions 45, 46.

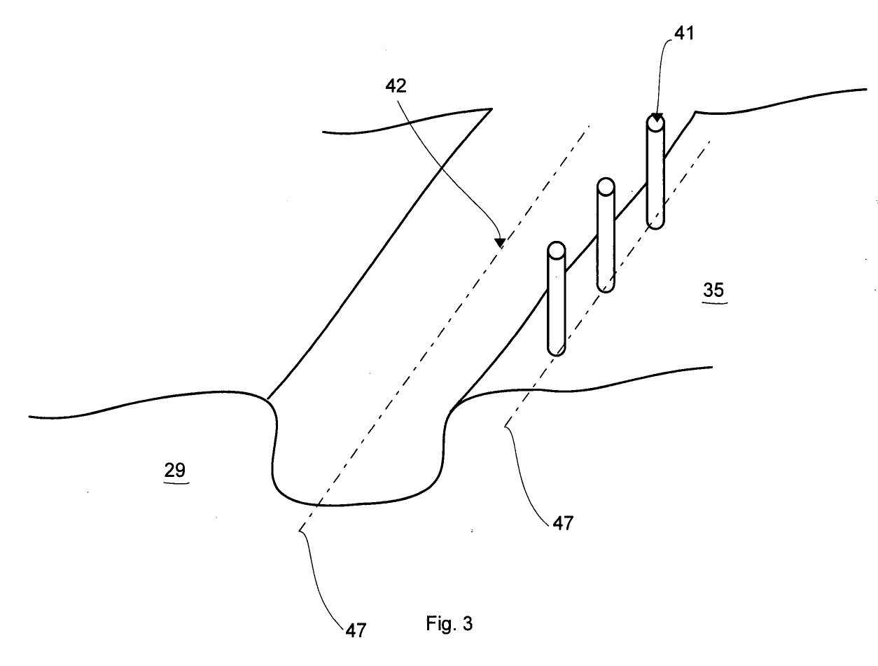

Depending on the quality of the 3-D camera and the image recognition software assigned to it, a more or less realistic image 29 of territory 35 sensed by particular 3-D camera 43 can be created—as shown in FIG. 3—that precisely depicts optical reference lines 38 of territory 35 which, in this case, are driving paths 42 and plant row 40. A suitable image recognition software can subsequently convert optical reference lines 38 mathematically into a substitute tracking line 47, out of which steering signal 30 can be derived. The result is that steering circuit 5 is regulated such that agricultural working machine 1 follows at least one substitute tracking line 47 that represents an optical reference line 38.

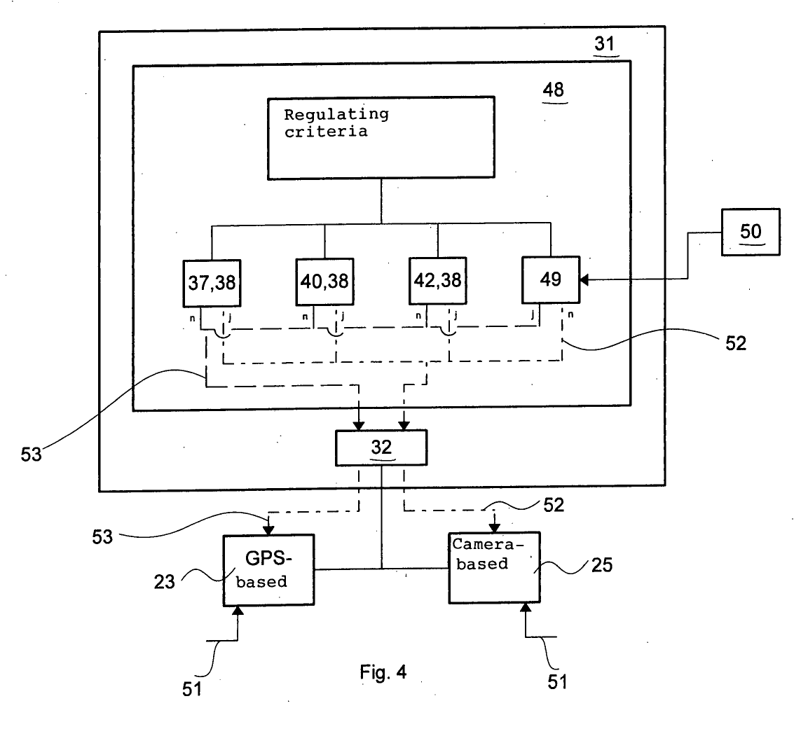

Since the camera-based determination of optical reference lines 38 in a territory 35 to be worked regularly depicts the actual local conditions on driving route 20 of particular agricultural working machine 1 better than is the case with GPS-based driving route detection systems 23, it is advantageous that it is possible to switch between camera-based and GPS-based driving route detection systems 23, 25, depending on the structure of territory 35 to be worked. In a preferred exemplary embodiment, this switch between driving route detection systems 23, 25 according to FIG. 4 is made dependent on regulating criteria 48.

In the current case, the regulating criteria can be the presence or absence of optical reference lines 38, such as stand edge 37, a driving path 42 and plant rows 40 in territory 35 to be worked, or predefined driving routes 49 of a route planning system 55 that is known per se and will therefore not be described in greater detail. In the simplest case, driver 12 of agricultural working machine 1 selects suitable driving route detection system 23, 25 himself via activation 51, e.g., of an activation switch. In this case, driver 12 must evaluate the structure of territory 35 to be worked or the availability of a route planning system 50. A design that relieves driver 12 of a great deal of work is attained when a data processing system 31 checks regulating criteria 48 and controls controller 32 directly to activate suitable driving route detection system 23, 25.

In the principal applications depicted in FIG. 2, the manner in which territory 35 to be worked is driven over plays a key role only in the application shown on the right, since, in this case, if tractor 2 strays from an optimum driving track 20, wheels 13, 14 pass over growing stand 41 and damage it. In this application 52, driver 12 or data processing unit 31 would then select camera-based driving-route detection system 25, since this driving route detection system 25 better depicts the real conditions in territory 35 to be worked. The same applies when inventive track-following system 24 cannot access predefined driving routes 49 of a route planning system 50. In the other application 53, namely when driving over territory 35 is inconsequential, since the stand cannot be damaged or optical reference lines 38 do not exist in territory 35 to be worked and predefined driving routes 49 are available, GPS-based driving route detection system 23 is activated. For simplicity, the driving paths are labeled in FIG. 4 with a “j” for “yes” and with a “n” for “no” if the particular condition exists or does not exist, respectively.

It is within the scope of the present invention that, to attain a great deal of flexiblity with the inventive steering system, controller 32 can also be designed such that it is freely programmable, so that highly diverse decision-making criteria 48 can be defined for highly diverse applications. In addition, controller 32 can be designed such that it is also data processing device 16, 27 of particular driving route detection systems 23, 25, so that all system functions can be carried out using a single component. In this case, controller 32 generates particular steering signals 22, 30 directly.

Since the electronic detection of driving tracks 20 that were covered can be used, in particular, to create historic data cadastres, based on which driving routes 49 to be worked in the future can be generated, it is advantageous when, if the camera-based driving route detection system is activated, driving route 20 is simultaneously recorded by recording the position data of GPS-based, further driving route detection system 23. This has the advantage, in particular, that future working processes can access these driving routes 49, which more accurately depict the actual conditions in territory 35 to be worked.

Given that controller 32 and data processing devices 16, 27 are combined into a single data processing device 31 and are integrated in particular agricultural working machine 1, 2, 33, a modular design of inventive track-following system 24 can be realized that makes it possible to replace driving route detection systems 23, 25 in any combination.

It will be understood that each of the elements described above, or two or more together, may also find a useful application in other types of constructions differing from the types described above.

While the invention has been illustrated and described as embodied in a steering system for a vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A steering system for a vehicle, comprising at least one data processing device; a track following system for determining a driving route and enabling the vehicle to be steered automatically via said at least one data processing device, said track following system including at least one first driving route detection system and at least one further driving route detection system, said driving route detection systems being coupled via said at least one data processing device such that it is possible to switch between said driving route detection systems.

2. A steering system as defined in claim 1, wherein said first driving route detection system is a GPS-based driving route detection system.

3. A steering system as defined in claim 1, wherein said further driving route detection system is a camera-based driving route detection system.

4. A steering system as defined in claim 3, wherein said camera-based driving route detection system has a camera which is configured as a 3-D camera.

5. A steering system as defined in claim 4, wherein said 3-D camera system is a system selected from the group consisting of a two-camera system offset at an angle, a 2-D camera with transit-time measurement, and both.

6. A steering system as defined in claim 1, wherein said driving route detection systems are switchable from one driving route detection system to another driving route detection system in a manner selected from the group consisting of based on regulating criteria, by an operator, and both.

7. A steering system as defined in claim 6, wherein at least one of said regulating criteria includes a presence or an absence of optical reference lines in a territory to be worked.

8. A steering system as defined in claim 7, wherein said optical reference lines are formed as elements selected from the group consisting of driving paths, plant rows, stand edges, and combinations thereof.

9. A steering system as defined in claim 7, wherein said track following system is operated by one of said driving route detection systems that includes a camera, in a situation selected from the group consisting of when optical reference lines in a territory are present, when digitized driving routes are not available for the territory to be worked, and both.

10. A steering system as defined in claim 7, wherein said track following system is operated by one of said driving route detection systems which is configured as a GPS-based driving route detection system, in a situation selected from the group consisting of when optical reference lines in a territory to be worked are missing, when a digitized driving routes are not available for the territory to be worked and both.

11. A steering system as defined in claim 1, wherein said one of said driving route detection system is a GPS-based driving route detection system, while another of said driving route detection systems is a driving route detection system that includes a camera; and further comprising a controller which links said driving route detection systems with each other, said controller also linking said driving route detection systems with a steering circuit.

12. A steering system as defined in claim 11, wherein said controller is programmable, and regulating criteria for selecting a corresponding one of said driving route detection systems are defined.

13. A steering system as defined in claim 11, wherein said controller is configured so that it generates steering signals for the steering circuit out of output signals of said driving route detection systems.

14. A steering system as defined in claim 1, wherein one of said driving route detection systems is a camera-based driving route detection system, while another of said driving route detection systems is a GPS-based driving route detection system, said driving route detection systems are linked with one another so that when the vehicle is operated using said camera-based driving route detection system, a driving route is recorded in a geo-referenced manner in conjunction with said GPS route detection system.

15. A steering system as defined in claim 1, wherein said track following system is configured as a modular system, and said driving route detection systems are integrated in said track following system in a replaceable manner.
